(19) United States
(12) Patent Application Publication
(10) Pub. No.: US 2013/0332868 A1
(43) Pub. Date: Dec. 12, 2013

(54) FACILITATING USER-INTERACTIVE NAVIGATION OF MEDICAL IMAGE DATA

(71) Applicant: Jens Kaftan, Oxfordshire (GB)

(72) Inventor: Jens Kaftan, Oxfordshire (GB)

(21) Appl. No.: 13/913,842

(22) Filed: Jun. 10, 2013

(30) Foreign Application Priority Data
Jun. 8, 2012 (GB) 1210172.1

(51) Int. Cl. G06F 3/0481

(52) U.S. Cl. CPC G06F 3/0481
USPC 715/764

(57) ABSTRACT

In a method and system for facilitating user-interactive navigation of medical image data, a set of medical imaging data of a subject is obtained and, from the medical imaging data an image volume reviewable by a user is generated. From the imaging data, a navigation map is generated that is a user-interactive image that shows the image volume. The navigation map is displayed alongside an image representing a region of the image volume. A selected part of the image volume is identified for review in response to a user selection of a location on the navigation map corresponding to the part.

### BACKGROUND OF THE INVENTION

1. Field of the Invention

The present invention concerns a method and a system that facilitate user-interactive navigation of medical image data.

2. Description of the Prior Art

With the financial resources for publicly available healthcare systems being very limited, the pressure for a reading physician to maximize the number of patient cases being read per day increases. At the same time the quality of each examination should not be sacrificed even with an increasing amount of available data per case due to recent advances in scanner hardware providing increased volume resolution. Hence an efficient workflow and methods for fast navigation within a volumetric dataset becomes more and more important. To guarantee that no lesion/pathology has been missed, the reading clinician needs to keep track of which image regions have been examined, to ensure efficiency and completeness of their examination. Such tracking must be performed for each modality in case of a multi-modality study.

Typically, a clinician reads the image volume on a slice-by-slice basis, frequently scrolling forward and backward over image data of certain body regions as necessary. While navigating through image data subsets, the clinician has to perform a complexity of other tasks, such as windowing, zooming, etc. to ensure an optimal visualization of each body region such that no lesion is missed. The image data subsets are typically slices, which are typically axial slices: that is to say, each slice represents an image taken perpendicular 30 to the head-to-toe axis of the patient.

The above is particularly true for whole-body PET/CT, MRI/PET, or SPECT/CT in clinical oncology, but is also true for any other modality and/or scan range, such as whole body scans, or scans of more restricted body area like thorax, head and neck. Beyond that, functional imaging such as PET or SPECT particularly features variable dynamic ranges, in each body part, that are additionally highly dependent on a variety of imaging and external factors. Hence, visualization parameters such as windowing need to be frequently adjusted depending on the organ/structure under scrutiny.

Different reading strategies have been adopted in clinical routine. Slices are either being read sequentially or on an organ basis, often requiring multiple forward and backward navigations over a region of interest or between different regions of interest. Additional tasks such as windowing and zooming are performed in parallel as needed.

More recently, UK Patent Application No. GB 1210155.6 proposes to define organ-specific workflows that store settings for visualization parameters such as windowing and zooming parameters.

The following documents may provide background information:

U.S. Patent Application Nos. 61/539,556 and 13/416,508, both of Siemens Corporation.

### SUMMARY OF THE INVENTION

Embodiments of this invention address a twofold problem. Embodiments of the present invention aim to provide efficient and structured navigation on an organ-basis minimizing distraction from other tasks such as windowing to ensure an appropriate visualization. Embodiments of the present invention aim to provide automatic tracking of body regions that have been reviewed. This is particularly advantageous when a clinician chooses not to read all slices one by one from top to bottom or vice versa. Some embodiments of the present invention address both of these issues.

### BRIEF DESCRIPTION OF THE DRAWINGS

FIG. 1 shows example image displays according to an embodiment of the invention.

FIG. 2 shows an example image display according to another embodiment of the invention.

### DESCRIPTION OF THE PREFERRED EMBODIMENTS

Embodiments of the invention introduce a navigation map of body and segmentation outlines for efficient navigation purposes, that is to say, efficient selection and viewing of subsets of medical image data. The segmentation typically corresponds to organ outlines.

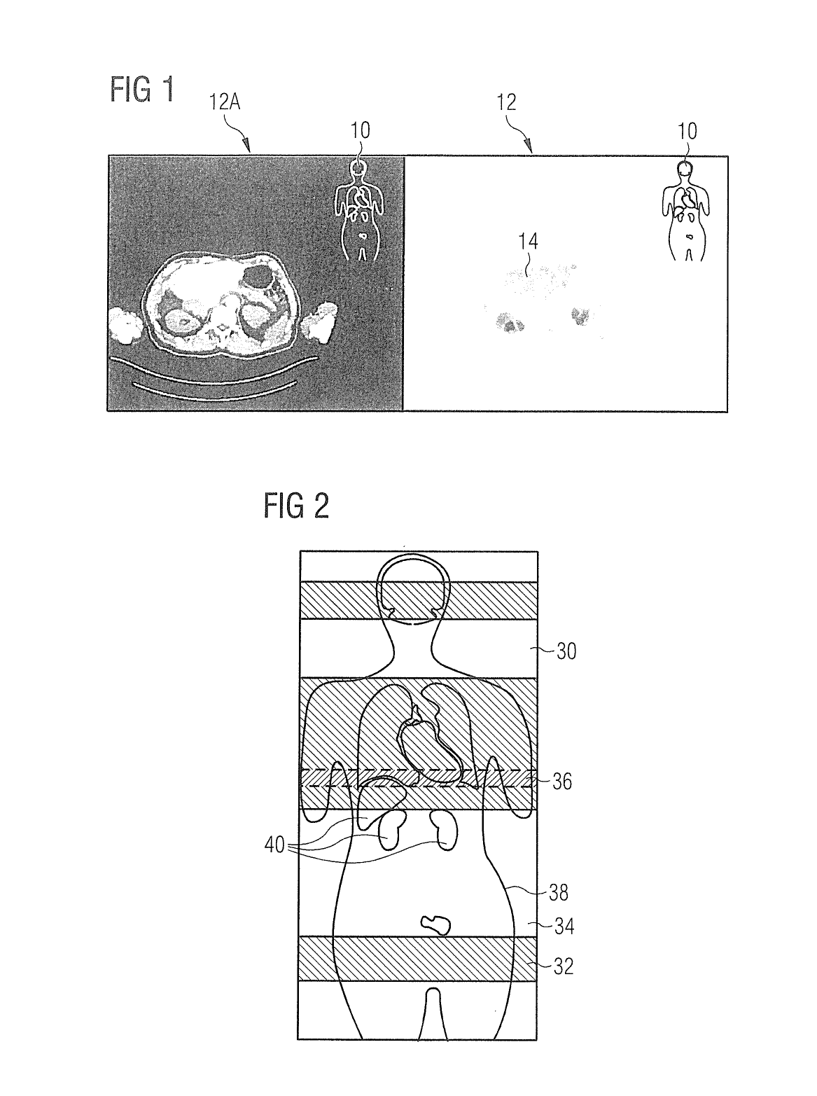

Such navigation map can be viewed as “navigation-mini-map” 10 displayed alongside a rendering area 12, 12A for viewing image data as exemplarily shown in FIG. 1.

In some embodiments of the invention, the displayed navigation-mini-map 10 enables selection of subsets of image data for viewing in rendering area 12, 12A by selection of a segmentation outline in the navigation-mini-map.

In some embodiments, the navigation-mini-map 10 indicates which subset(s) of data 14 is/are presently being viewed, or have already been viewed. Such subsets may be expressed as segmentation regions representing organs; or slices of data.

The navigation-mini-map 10 may show an outline of all body regions that are present in the current image dataset. The map may be shown in coronal view, as shown, as that is believed to offer the most intuitive interface to the clinician.

In some embodiments, only a part of the navigation map may be shown, for example representing only a presently-viewed organ or data slice, or a region around a presently-viewed organ or data slice. Each subset, such as slice or organ, is selectable on the navigation-mini-map and triggers the navigation of the current view(s) 12, 12A to the organ or data slice selected on the navigation-mini-map. Region-specific visualization settings may be retrieved and applied as appropriate to the selected region. A visual feedback may be provided, keeping track of the slices or organs that have already been reviewed by display on the navigation-mini-map.

FIG. 1 shows an example display representing displayed images 12, 12A according to a realization of the present invention. Medical image data 14 from two different modalities are on display. In the left-hand side, CT data is shown. In the right side, PET data are shown. Preferably, both views are synchronized, so that the two views represent a same region of the patient's body. However, it may be possible to release this synchronization so that different regions may be represented on the left-hand side 12A and the right-hand side 12. It may also be possible to show different regions in a same modality.

The body and organ outlines of the navigation-mini-map 10 reflect segmentation results and hence represent the patient's anatomy in scale, organ localization, etc. The navigation map may simply be a static outline of a sample anatomy.

Preferably, however, the navigation-mini-map represents the range of the current image dataset and the spatial relationship between the organs represented in the current image dataset. For this purpose, a multitude of landmarks can be detected to estimate the imaged body regions and the most probable location and boundaries of the major organs, for example as described in S. Seifert, A. Barbu, S. Zhou, D. Liu, J. Feulner, M. Huber, M. Suchling, A. Cavallero, D. Comaniciu, “Hierarchical Parsing and Semantic Navigation of Full Body CT Data”, SPIE 2009. This information can be combined with sample organ contours to create a navigation map suitable for use according to the present invention. In such an embodiment, the extracted anatomical information is used to determine which organs are present in the imaging data, with sample contours corresponding to the identified organs being placed on the navigation mini-map. The landmarks identified in the image dataset may be used to determine the spatial relation of the identified organs to each other, and/or scaling information for each individual organ.

In a more complex embodiment, the navigation-mini-map can be furthermore personalized to the anatomy of the current patient by actually segmenting the body outline and/or major organs of the current image data set and generating the navigation map using resulting contours or silhouettes. A suitable method for such segmentation is described in T. Kohlberger, M. Sofka, J. Zhang et al., “Automatic Multi-Organ Segmentation Using Learning-based Segmentation and Level Set Optimization”, MICCAI 2011, Springer LNCS 6893.

By selecting an organ/structure in the navigation map, typically by clicking on it with a mouse or similar pointing device, the system navigates to this organ and optionally may change visualization parameters such as windowing and zooming based on pre-defined values or values derived directly from the segmentation results. Selection of an organ may result in the selection of an image data segment which includes a center of the selected organ, or a topmost slice of image data including a portion of the selected organ, or a bottommost slice of image data including a portion of the selected organ.

Particularly if implemented as navigation-mini-map, the selection of an individual organ might be difficult due to its scale. For this purpose, one possible realization may highlight the organ a pointing device currently points to, for example by changing the color of the contour or the background color of the organ.

FIG. 2 shows an example of a navigation map 30 according to another embodiment of the present invention. Image data subsets, which in this example are slices, which have already been reviewed are highlighted by use of a background color 32 which differs from a background color 34 used to indicate image data subsets which have not yet been viewed. A further background color 36 may be used to indicate a presently-viewed image data subset in order to provide context in respect of its position within the body and an indication of whether neighboring image data subsets have been viewed.

In this embodiment of the present invention, a user may select an image data subset within the navigation map, for example using a pointer device, resulting in viewing of the corresponding selected image data subset.

Allowing the user to change easily from viewing one organ, slice or ROI to another by using the navigation map of the present invention additionally complicates the task of keeping track of which parts of the image data have already been reviewed. For this purpose, certain embodiments of the present invention automatically keep track of the image data subsets, such as axial slices, that have been rendered for display and review during the navigation process. These are marked 32 in the navigation map 30, as illustrated in FIG. 2. This allows the reading clinician to identify easily those slices/blocks that have not yet been reviewed. Preferably, the user may navigate to previously unvisited slices/blocks, for example by clicking on a slice position outside the body outline. Clicking within the body outline may select a corresponding organ segmentation. In case of multi-modality studies, the system can keep track of the reviewed image data subsets on a per-modality basis, and the result may be visualized, for example by using different colors to mark slices which have been read in modality A, modality B, or both of these modalities.

Note that in certain embodiments of the present invention, the full functionality described above may only be possible where the navigation map 30, 10 reflects the individual patient's own body anatomy and/or the spatial relationship between the identified organs. However, it is not necessary that the navigation map 30, 10 actually shows a dataset-specific map. As long as the system knows the relevant parameters such as the spatial relationships, and can identify organ boundaries within the individual patient's dataset, the same functionality may be realized with a static outline of a sample anatomy.

In another embodiment, the present invention provides a map for a particular organ. This may be in addition to the body mini-map, and may be for an organ shown on that map. This gives greater detail in assessment of exactly which parts of the organ the clinician has already reviewed, and greater accuracy in selecting parts of the organ to review. Alternatively, some of these advantages may be provided by a zoom function used with the whole body navigation map 30, 10.

The present invention accordingly provides a system and a method that generates a navigation map 30, 10 for visualization of medical image data. The navigation map 30, 10 may be based on landmark/organ detection or segmentation.

The following stages may be provided by the present invention.
Organs/body regions present in the image data are identified.
A map 30, 10 is constructed which reflects the spatial range of the image data and the spatial correlation between the identified organs 40.
Selection of each organ/structure visualized in the navigation map is enabled, in response to selection of the appropriate region of the map.
The selection of an organ/structure on the navigation map triggers navigation to the selected organ/structure for visualization of the corresponding image data.
Relevant visualization parameters are adjusted dependent on the selection. Such parameters may be adjusted using pre-defined values, or by automatically computing values according to the selected image data.
The visited slices may optionally be tracked and the visited slices may be highlighted as regions of the navigation map. Such visualization may assist in guiding a user to view previously unseen parts of the image dataset based on the navigation map.

Manually or automatically detected findings could be additionally incorporated into the navigation-mini-map 10 to create a simplified 2D overview image, which roughly indicates the location of the lesions in relation to major organs. Such automatically generated schematic drawing could be added to a patient report and/or used for communicating results to the patient in a simple and easily understandable manner.

The present invention also provides a system arranged to perform any one or more of the methods of the present invention discussed above. Such a system may include a general-purpose computer that is suitably programmed to cause the invention to be implemented/executed. The present invention extends to a data carrier containing encoded instructions which, when executed on a general purpose computer, cause that computer to be a system according to the present invention.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method of facilitating user-interactive navigation of medical image data, comprising:
obtaining a set of medical imaging data of a subject;
generating from the medical imaging data an image volume reviewable by a user;
generating, from the imaging data a navigation map as a user-interactive image that shows a representation of identified regions within of the image volume;
displaying the navigation map alongside an image representing a part of the image volume; and
identifying a selected region of the image volume for review in response to a user selection of a location on the navigation map corresponding to the region.

2. A method according to claim 1 further comprising segmenting the image volume into a plurality of regions of interest; and wherein generating the navigation map comprises representing the segmentation of the image volume on the navigation map.

3. A method according to claim 2, comprising displaying the segmentation of the entire image volume in the navigation map.

4. A method according to claim 2, comprising displaying only a part of the entire image volume, comprising a selected segmentation in the navigation map.

5. A method according to claim 1 further comprising identifying landmarks within the image volume to estimate imaged body regions and to identify probable locations and boundaries of organs, and wherein generating the navigation map comprises representing sample organ contours on the navigation map, said represented sample organ contours corresponding in position to the identified probable locations and boundaries of the estimated imaged body regions.

6. A method according to claim 5, further comprising determining a spatial relation between the identified organs, by reference to the identified landmarks, and representing the sample image contours on the navigation map according to the determined spatial relationship.

7. A method according to claim 5, further comprising determining scaling factors of the identified organs, by reference to the identified landmarks, and representing the sample image contours on the navigation map according to the determined scaling factors.

8. A method according to claim 1, further comprising:
on viewing of a region of the image volume by the user, recording a location of the viewed region; and
using the recorded location in addition to generate the navigation map, the navigation map displaying the location of the viewed region of the image volume.

9. A method of tracking user interaction with medical image data, comprising:
obtaining a set of medical imaging data of a subject;
generating from the medical imaging data an image volume reviewable by a user;
on viewing of a portion of the image volume by the user, recording a location of the viewed portion;
generating from the imaging data, an image volume segmentation, and the recorded location, a navigation map displaying the segmentation and a representation of the image volume and the location of the viewed portion of the image volume in said navigation map; and
identifying a selected region of the image volume for review in response to a user selection of a location on the navigation map corresponding to the region.

10. A method according to claim 9, comprising segmenting the imaging data by anatomical region, and wherein said portion of the image volume is a segmented anatomical region.

11. A method according to claim 9, wherein said portion is a slice.

12. A method according to claim 9, wherein identifying a selected region of the image volume for review in response to a user selection of a location on the navigation map corresponding to the region results in selecting a topmost slice of image data comprising a part of the selected region.

13. A method according to claim 1, wherein identifying a selected region of the image volume for review in response to a user selection of a location on the navigation map corresponding to the region results in selecting a bottommost slice of image data comprising a part of the selected region.

14. A method according to claim 1, wherein identifying a selected region of the image volume for review in response to a user selection of a location on the navigation map corresponding to the region results in selecting a slice of image data comprising a center part of the selected region.

15. A system for facilitating user-interactive navigation of medical image data, comprising:
a computerized processor supplied with a set of medical imaging data of a subject;
said processor configured to generate from the medical imaging data, an image volume reviewable by a user;
said processor being configured to generate, from the imaging data, a navigation map as a user-interactive image that shows the image volume;
a display unit in communication with said processor, said processor being configured to cause the navigation map to be displayed at said display unit alongside an image representing a part of the image volume;
a user interface in communication with said processor, said user interface and said processor being configured to allow a user to make a user selection of a location on the navigation map; and
said processor being configured to identify a selected part of the image volume at said display unit for review, in response to said user selection that corresponds to the location on the navigation map defined by said user selection.

16. A system of tracking user interaction with medical image data, comprising:
a computerized processor supplied with a set of medical imaging data of a subject;
said processor being configured to generate, from the medical imaging data, an image volume reviewable by a user;
a display unit in communication with said processor;
said processor being configured upon viewing of a portion of the image volume by the user, at said display unit, to record a location of the viewed portion;
said processor being configured to generate from the imaging data, an image volume segmentation, and the recorded location, a navigation map that shows the segmentation and a representation of the image volume and the location of the viewed portion of the image volume in said navigation map; and
a user interface in communication with said processor, said user interface and said processor being configured to allow a user to make a user selection of a location on the navigation map; and
said processor being configured to identify a selected region of the image volume at said display unit for review, in response to said user selection that corresponds to the location on the navigation map defined by said user selection.

17. A non-transitory, computer-readable data storage medium encoded with programming instructions, said storage medium being loaded into a computerized processor that is in communication with a display unit, and said programming instructions causing said computerized processor to:
receive a set of medical imaging data of a subject;
generate from the medical imaging data, an image volume reviewable by a user;
generate from the imaging data, a navigation map, as a user-interactive image that shows a representation of identified regions within of the image volume;
cause the navigation map to be displayed at the display unit alongside an image representing a part of the image volume; and
identify a selected region of the image volume for review in response to a user selection of a location on the navigation map corresponding to the region.

18. A non-transitory, computer-readable data storage medium encoded with programming instructions, said storage medium being loaded into a computerized processor that is in communication with a display unit, and said programming instructions causing said computerized processor to:
receive a set of medical imaging data of a subject;
generate, from the medical imaging data, an image volume reviewable by a user;
on viewing of a portion of the image volume by the user, record a location of the viewed portion;
generate from the imaging data, an image volume segmentation, and the recorded location, a navigation map that shows the segmentation and a representation of the image volume and the location of the viewed portion of the image volume in said navigation map; and
identify a selected region of the image volume for review in response to a user selection of a location on the navigation map corresponding to the region.
